(19) United States
(12) Patent Application Publication
(10) Pub. No.: US 2025/0272991 A1
(43) Pub. Date: Aug. 28, 2025

(54) Method and system for object detection by using hybrid deep learning model

(71) Applicant: Hoseo University Academic Cooperation Foundation, Asan-si (KR)

(72) Inventor: Huhn Kuk LIM, Daejeon (KR)

(21) Appl. No.: 18/945,933

(22) Filed: Nov. 13, 2024

(30) Foreign Application Priority Data
Feb. 22, 2024 (KR) 10-2024-0025925

(51) Int. Cl. G06V 20/58; G06V 10/25; G06V 10/40; G06V 10/764; G06V 10/82

(52) U.S. Cl. CPC G06V 20/58; G06V 10/25; G06V 10/40; G06V 10/764; G06V 10/82

(57) ABSTRACT

A method and system for object detection using a hybrid deep learning model that combines the strengths of the YOLO and Faster R-CNN frameworks. The method detects all objects within a given frame using YOLO and selects a bounding box around each object. Region of Interest (RoI) pooling, borrowed from Faster R-CNN, is then used for object segmentation and classification, thereby improving detection accuracy. This approach enhances the precision of object detection in real-time scenarios.

### BACKGROUND OF THE INVENTION

### 1. Field of the Invention

The present invention relates to a method and system for object detection using a hybrid deep learning model, and more specifically, to a method and system for object detection that utilizes a hybrid deep learning model combining the strengths of the YOLO and Faster R-CNN frameworks.

### 2. Description of the Related Art

The automotive industry is rapidly evolving with the integration of artificial intelligence (AI) technology. The global market for in-vehicle AI is expected to show significant growth, with in-vehicle AI software projected to reach $6.6 billion by 2025, expanding at an average annual growth rate of 36.15%. Object detection plays a crucial role in autonomous driving systems, enabling self-driving cars to accurately recognize and classify surrounding objects.

Generally, there are two main strategies for object detection: a two-stage approach and a single-stage approach. Two-stage approaches, such as R-CNN (Region-based CNN) and Faster R-CNN, are widely adopted in academia and industry due to their high accuracy. These methods use a Region Proposal Network (RPN) to generate potential object proposals, followed by classification and bounding box regression steps. However, these approaches often struggle to meet the real-time processing requirements for object detection in vehicles.

On the other hand, single-stage approaches, exemplified by YOLO (You Only Look Once) and SSD (Single Shot Detector), are known for their fast processing speed. These methods directly predict object classes and bounding box coordinates from a single evaluation of the network. While they achieve real-time performance, their accuracy can sometimes be lower in certain scenarios. Despite their advantages, detecting objects of varying sizes and identifying objects in challenging driving conditions remain significant challenges for these single-stage approaches.

To overcome the limitations of both two-stage and single-stage methods, there has been a growing interest in hybrid approaches that leverage the strengths of both paradigms. These hybrid models aim to achieve a balance between accuracy and speed in object detection tasks. However, the need arises for improved object detection AI models for autonomous vehicles, due to fundamental problems faced in object recognition, such as image diffusion, blurring, and motion, especially in smart city environments. Additionally, there are practical constraints in certain environments, such as limited computational resources and latency issues, which make it challenging to identify objects quickly and accurately.

### SUMMARY OF THE INVENTION

The present invention has been devised to solve these problems by providing a method and system for object detection using a hybrid deep learning model. The invention utilizes YOLO to detect all objects within a given frame and select a bounding box around each object. It then adopts Region of Interest (RoI) pooling from Faster R-CNN for object segmentation and classification, thereby improving accuracy. The primary objective of this invention is to offer an object detection method and system using a hybrid deep learning model that combines these techniques.

To accomplish this objective, there is provided a method for object detection by using a hybrid deep learning object detection model, comprising: (a) collecting captured images in real time; (b) performing preprocessing on the collected image data; (c) inputting the preprocessed image data into the hybrid deep learning object detection model to execute the model algorithm; and (d) outputting classification or segmentation from the hybrid deep learning object detection model.

In the method, the step (c) may includes: (c1) extracting a bounding box for feature extraction from the preprocessed image data; and (c2) outputting classification or segmentation from the image in which the bounding box has been extracted.

Preferably, the extraction of the bounding box in step (c1) includes inputting the preprocessed image data into the YOLO block of the hybrid deep learning object detection model, wherein the bounding box is extracted by the YOLO model.

Preferably, the step (c2) includes: (c21) inputting the image, from which the bounding box has been extracted, into the Faster R-CNN block of the hybrid deep learning object detection model; (c22) performing Region of Interest (RoI) pooling on the input image in the Faster R-CNN block; and (c23) inputting the RoI pooled images into the Fully Connected CNN of the Faster R-CNN block, wherein the output of the Fully Connected CNN in step (c23) is processed by a softmax classifier to output classification or segmentation in step (d).

According to another aspect of the present invention, there is provide a system for object detection by using a hybrid deep learning model, comprising: at least one processor; and at least one memory storing computer-executable instructions that, when executed by the at least one processor, cause the system to: (a) collect captured images in real time; (b) perform preprocessing on the collected image data; (c) input the preprocessed image data into the hybrid deep learning model; and (d) output classification or segmentation from the hybrid deep learning model.

In the system, the step (c) may include (c1) extracting a bounding box for feature extraction from the preprocessed image data; and (c2) outputting classification or segmentation from the image in which the bounding box has been extracted.

Preferably, the extraction of the bounding box in step (c1) includes inputting the preprocessed image data into the YOLO block of the hybrid deep learning object detection model, wherein the bounding box is extracted by the YOLO model.

Preferably, the step (c2) includes: (c21) inputting the image, from which the bounding box has been extracted, into the Faster R-CNN block of the hybrid deep learning object detection model; (c22) performing Region of Interest (RoI) pooling on the input image in the Faster R-CNN block; and (c23) inputting the RoI pooled images into the Fully Connected CNN of the Faster R-CNN block, wherein the output of the Fully Connected CNN in step (c23) is processed by a softmax classifier to output classification or segmentation in step (d).

According to still another aspect of the present invention, there is provided a computer-readable non-transitory storage medium storing instructions that, when executed by a processor, cause the processor to: (a) collect captured images in real time; (b) perform preprocessing on the collected image data; (c) input the preprocessed image data into a hybrid deep learning model; and (d) output classification or segmentation from the hybrid deep learning model.

According to the present invention, an object detection method and system using a hybrid deep learning model is provided, which offers the advantage of improved accuracy. This is achieved by using YOLO to detect all objects in a given frame and select a bounding box around each object, while adopting Region of Interest (RoI) pooling from Faster R-CNN for object segmentation and classification.

### BRIEF DESCRIPTION OF THE DRAWINGS

FIG. 1 is a diagram illustrating the object detection process of the hybrid deep learning model in an autonomous vehicle according to the present invention.

FIG. 2 is a diagram showing the network structure of the hybrid deep learning model of the present invention.

FIG. 3 is a diagram depicting the hybrid deep learning model that combines the features of YOLO and Faster R-CNN according to the present invention.

FIG. 4 is a flowchart of the object detection method using the hybrid deep learning model in an autonomous vehicle according to the present invention.

FIG. 5 is a diagram showing an example of a dataset containing images and labels.

FIG. 6 is a diagram comparing the mean average precision (mAP) concerning inference time among various recent object detection models.

FIG. 7 is a diagram comparing confidence concerning recall values among various recent object detection models.

FIG. 8 is a diagram comparing the processing speed of various recent object detection models.

FIG. 9 is a diagram illustrating the configuration of an object detection system (100) using a hybrid deep learning model.

### DETAILED DESCRIPTION OF THE INVENTION

The preferred embodiments of the present invention will be described in detail below with reference to the accompanying drawings. Prior to this, the terms and words used in this specification and the claims should not be construed as being limited to conventional or dictionary meanings. Instead, they should be interpreted in accordance with the principle that the inventor can appropriately define the concepts of the terms to best describe their invention. Therefore, the embodiments described in this specification and the configurations shown in the drawings are merely the most preferred examples of the present invention and do not represent all of the technical ideas of the invention. Accordingly, it should be understood that various equivalents and modifications can be made to replace these embodiments at the time of this application.

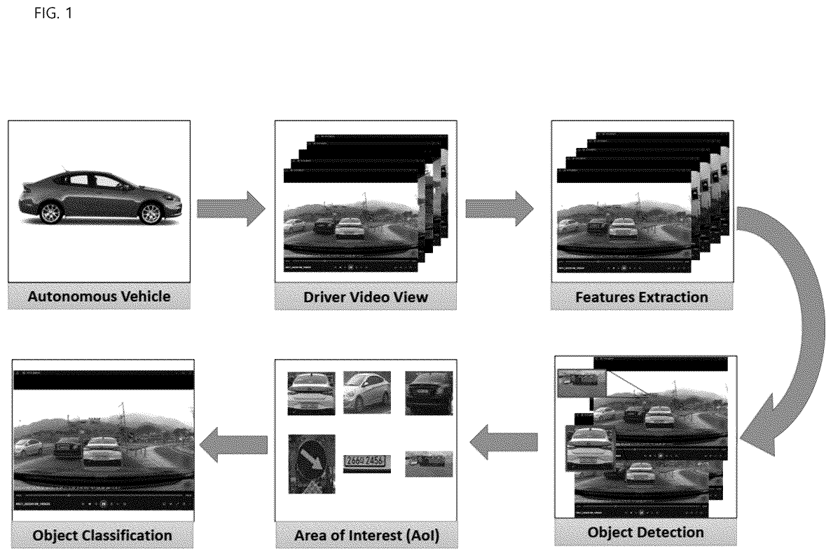

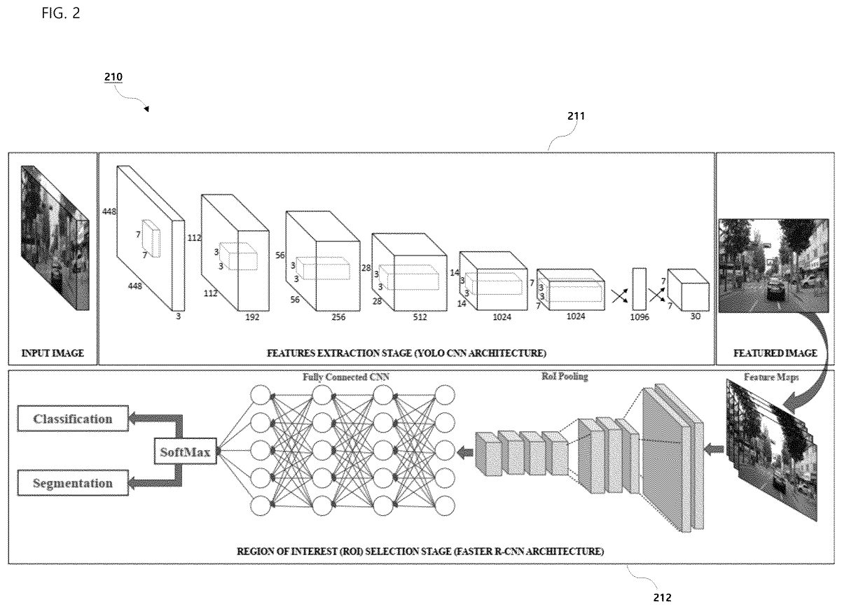

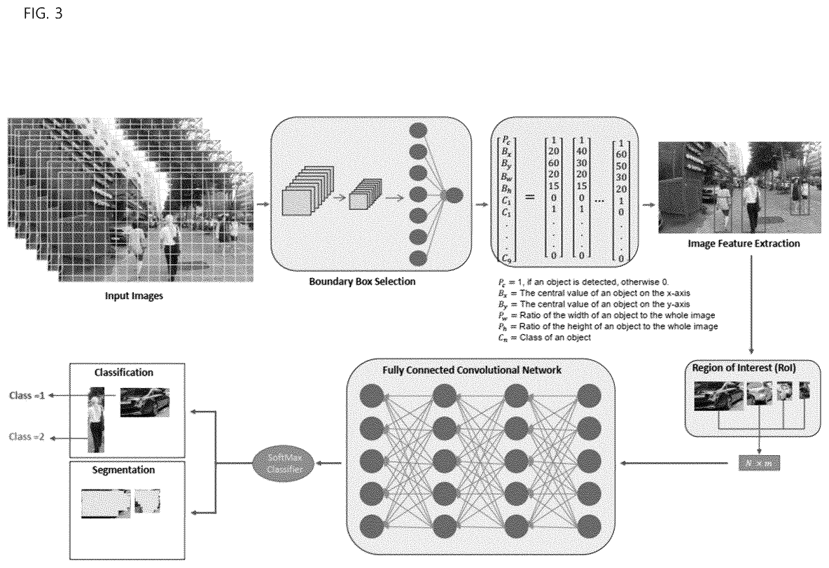

FIG. 1 illustrates the object detection process of the hybrid deep learning model of the present invention in an autonomous vehicle. FIG. 2 shows the network structure of the hybrid deep learning model of the present invention, and FIG. 3 depicts the hybrid deep learning model that combines the features of YOLO and Faster R-CNN.

The hybrid model of the present invention is designed to improve accuracy while maintaining real-time processing capability by integrating the concepts of YOLO and Faster R-CNN. Specifically, it combines the efficient object detection of YOLO for selecting bounding boxes with the Region of Interest (RoI) pooling mechanism of Faster R-CNN for precise segmentation and classification. During this process, the structure of Faster R-CNN bypasses the Region Proposal Network (RPN), thereby further accelerating processing time without a significant loss in accuracy.

The hybrid approach of the present invention, which utilizes the combination of the YOLO framework 211 (see FIG. 2) and the Faster R-CNN framework 212 (see FIG. 2) along with the integration of a local traffic dataset, represents a significant advancement in achieving higher accuracy than YOLOv5 and YOLOv7 while supporting real-time speed in autonomous vehicle operations. Furthermore, the hybrid approach of the present invention is considered an effective object detection method in vehicle environments.

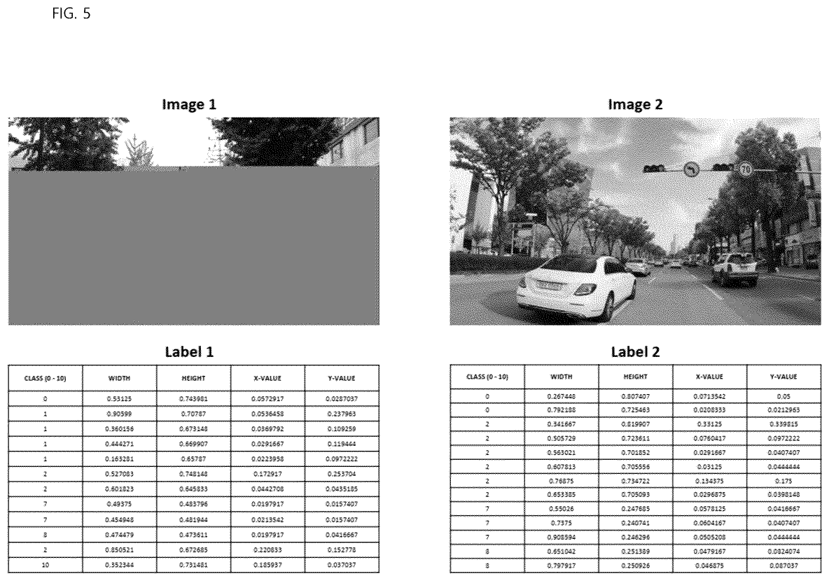

The following description explains the hybrid approach of the present invention for object detection and its configuration with reference to FIGS. 1 to 3. Additionally, experimental results are presented with reference to FIGS. 5 to 8, including performance evaluations using actual data related to the present invention.

Here, we introduce a hybrid object detection model for vehicle communication that combines the YOLO and Faster R-CNN structures to accurately and efficiently detect and track objects in real driving scenarios.

FIG. 1 illustrates the object detection process of the model of the present invention used in autonomous vehicles. This process begins with the collection of real-time video captured by the vehicle in motion. The real-time video is then displayed on the driver's video viewer. The hybrid object detection model is used to extract features from the video. Using these unique features, the model detects various objects. Next, the Region of Interest (RoI) is activated, and the corresponding area is identified through pixel values. Finally, the extracted features are utilized to classify objects according to their types.

The network structure of the hybrid deep learning object detection model 210 of the present invention comprises multiple stages, as shown in FIG. 2.

The first stage is data collection, where data is gathered to train the object detection model in driving scenarios. The collected data is then preprocessed to make it suitable for training. This preprocessing includes resizing images, normalizing pixel values, and splitting the dataset into training and validation sets to evaluate the model's performance.

The next stage involves performing the YOLO model 211 to extract bounding boxes from the preprocessed images. YOLO 211 provides a fast and approximate object detection solution, making it suitable for real-time applications. Typically, each bounding box is represented by a set of six parameters: P_{c}, Bₓ, B_{y}, B_{w}, Bₕ, and Cₙ. Here, P_{c} denotes the probability that the object within the bounding box belongs to a specific class, while Bₓ, B_{y}, B_{w}, Bₕ, and Cₙ represent the center coordinates, width, height, and class number, respectively. Additionally, each bounding box is assigned a confidence prediction, which is calculated using the Intersection over Union (IoU) between the predicted box and the ground truth box. The IoU is calculated using the following formula:

$$IoU = \frac{Area of Overlap}{Area of Union} \qquad [ Equation 1 ]$$

After obtaining the bounding boxes and confidence predictions, the featured image passes through the Faster R-CNN block 212. In this block, Region of Interest (RoI) pooling is applied to extract the region's features. An RoI can be expressed as follows:

$$RoI pooling ( {P}_{i , k} ) = \frac{1}{n} {\sum }_{i = 1}^{n} {P}_{i , k} ( pool ( {h}_{j} , {w}_{j} , {x}_{j} , {y}_{j} ) ) \qquad [ Equation 2 ]$$

Here, P_{i,k} is the output of the feature map from the last convolutional layer for the i-th RoI, and k is the index of the corresponding channel. n is the number of sub-windows into which the RoI is divided. P_{i,k} (pool (hⱼ, wⱼ, xⱼ, yⱼ) is the activation value of the k-th channel in the j-th sub-window of the RoI. pool (hⱼ, wⱼ, xⱼ, yⱼ) represents the sub-window with a height of hⱼ, a width of wⱼ, and coordinates (xⱼ, yⱼ).

The features pooled through the RoI are then input into a fully connected CNN, where classification and segmentation tasks are performed. The activation function used in the CNN layer is the Rectified Linear Unit (ReLU), defined as follows:

$$ReLU = max ( 0 , x ) \qquad [ Equation 3 ]$$

Here, x is the input to the activation function, which returns x if x is positive, and 0 otherwise.

The softmax loss factor is used in the fully connected layer to calculate the loss and optimize the model during the training process. This loss function measures the discrepancy between the predicted class probabilities and the actual (ground truth) labels. It guides the model to assign higher probabilities to the correct object classes and lower probabilities to the incorrect ones.

The softmax cross-entropy loss factor equation is expressed as follows:

$${Loss}_{cls} = - \frac{1}{N} {\sum }_{i = 1}^{N} {\sum }_{j = 1}^{C} {y}_{ij} log ( {p}_{ij} ) \qquad [ Equation 4 ]$$

Here, N is the number of samples in the training batch, C is the total number of object classes, yᵢⱼ is the ground truth label indicating whether sample i belongs to class j, and pᵢⱼ is the predicted probability that sample i belongs to class j.

Finally, this model achieves accurate classification and segmentation results, enabling robust object detection in vehicle environments.

One noteworthy aspect is that the Region Proposal Network (RPN) is omitted in the Faster R-CNN stage. This is because the RPN is only used to generate region proposals, and since the YOLO framework already detects all objects within the frame, skipping the RPN reduces processing time, thereby speeding up the model. This is particularly beneficial when dealing with large datasets, as the RPN involves a significant amount of computation, which can be time-consuming. Therefore, the hybrid approach of the present invention employs only RoI pooling while removing the RPN, allowing the model to achieve practical real-time speed without compromising detection accuracy.

By minimizing this loss factor during the training process, the hybrid model of the present invention optimizes the softmax classifier, thereby enhancing its ability to accurately classify objects in real-world driving scenarios. The hybrid model of the present invention combines the architectures of YOLO and Faster R-CNN, achieving high accuracy and efficiency in real-time object detection and classification, especially in vehicle communication. YOLO is utilized for object detection and bounding box generation, while RoI pooling from Faster R-CNN is employed for segmentation and classification. This hybrid enables the model to detect and classify objects accurately and efficiently in real-time scenarios.

In FIG. 3, the hybrid model of the present invention, which combines the features of YOLO and Faster R-CNN architectures, can be seen. This model comprises several key components that work together to achieve accurate real-time object detection in autonomous driving scenarios.

To ensure the accuracy and efficiency of the hybrid model of the present invention, training was conducted using a large-scale image dataset. The images in this dataset contain eleven (11) different types of objects, including license plates, people, cars, motorcycles, buses, large trucks, small trucks, traffic lights, traffic signs, faces, and crosswalks. The dataset was carefully designed to cover a variety of scenarios and lighting conditions. By training the model on such a diverse dataset, the present invention's model is capable of accurately detecting and classifying these objects.

Overall, the hybrid model of the present invention demonstrates superior capability in detecting and recognizing a wide range of objects commonly encountered in vehicle environments, compared to other object detection models.

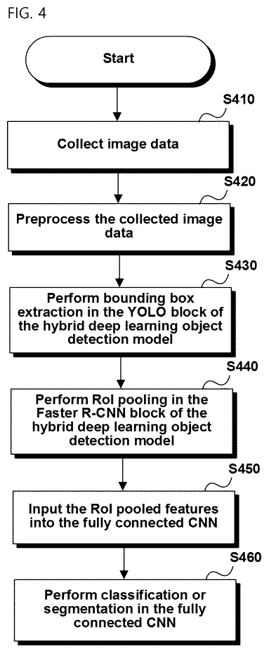

FIG. 4 is a flowchart of the object detection method in an autonomous vehicle using the hybrid deep learning model of the present invention. As this method has already been described in detail with reference to FIGS. 1 to 3, a brief summary of the steps is provided with reference to FIG. 4.

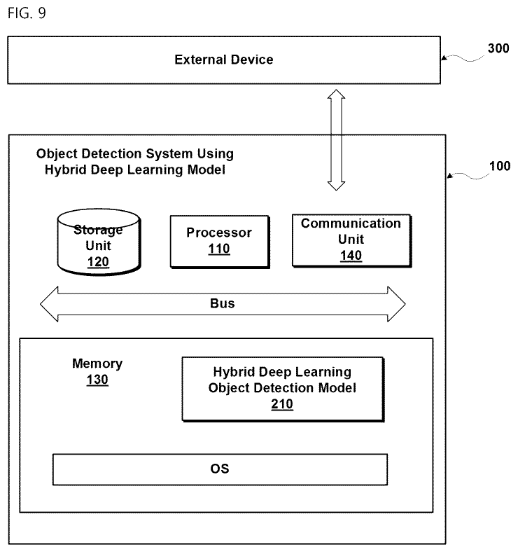

First, the object detection system 100 (see FIG. 9) using the hybrid deep learning model collects image data in real time from external devices 300, such as cameras (S410). The collected image data undergoes preprocessing (S420). The preprocessed image data is then passed to the YOLO block 211 (see FIG. 2) of the hybrid deep learning object detection model 210 (see FIGS. 2 and 9) to extract bounding boxes for feature extraction (S430).

The images with the extracted bounding boxes are input into the Faster R-CNN block 212 (see FIG. 2) of the hybrid deep learning object detection model 210 (see FIGS. 2 and 9). The Faster R-CNN block 212 performs Region of Interest (RoI) pooling on the input images (S440). The pooled RoI images are then input into the Fully Connected CNN of the Faster R-CNN block 212 (S450). Finally, the output of the Fully Connected CNN is processed by a softmax classifier to perform classification or segmentation (S460).

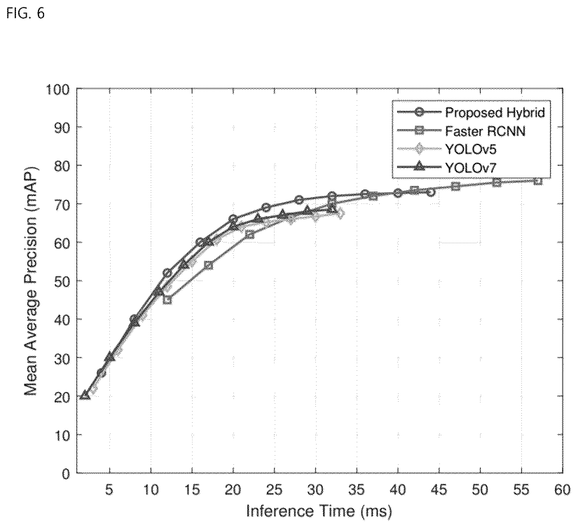

FIG. 5 shows an example of a dataset containing images and labels, while FIG. 6 compares the mean average precision (mAP) of various recent object detection models with respect to inference time.

The following section introduces the evaluation and performance of various object detection models for road traffic object detection in autonomous vehicles. A dataset consisting of 10,000 images was used to train and test all the object detection models. This dataset includes various types of vehicles, traffic signals, road signs, pedestrians, license plates, and more. A sample of this dataset is illustrated in FIG. 5.

To evaluate the performance of each model, the following metrics were measured: inference time, mean Average Precision (mAP), confidence, and recall values. Additionally, the average image processing speed was calculated and compared with the performance of the hybrid model of the present invention and other state-of-the-art models.

The performance of four different object detection models-namely, the hybrid model of the present invention, Faster R-CNN, YOLOv5, and YOLOv7—is shown in FIG. 6 in terms of mean Average Precision (mAP) and inference time (ms). Compared to all other models, the hybrid model of the present invention achieves the highest mAP within an inference time range of 4 ms to 44 ms. Specifically, the hybrid model of the present invention achieves mAP of approximately 26% at an inference time of 4 ms, 66% at 24 ms, and 73% at 44 ms. In contrast, the Faster R-CNN model achieves mAP of about 45% at an inference time of 12 ms and approximately 76% at an inference time of 57 ms. The YOLOv5 and YOLOv7 models achieve mAP of around 19% and 20%, respectively, at an inference time of 2 ms. However, at an inference time of 33 ms, YOLOv5 and YOLOv7 models achieve mAP of approximately 67.5% and 70%, respectively.

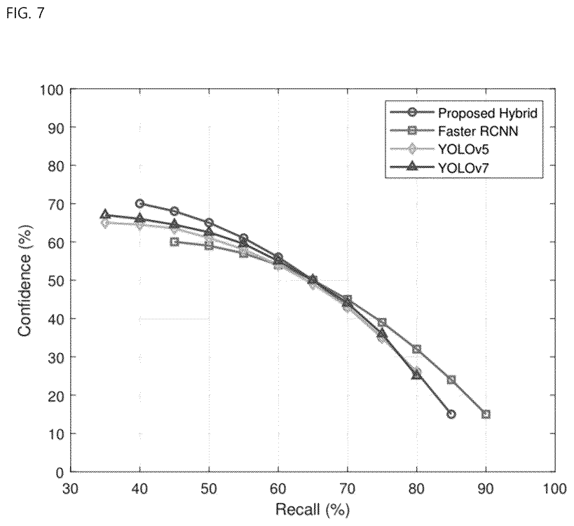

FIG. 7 is a diagram comparing the confidence for recall values across various recent object detection models. Confidence indicates the probability that a detection is accurate, while recall represents the proportion of actual positive detections among all possible positive detections. The x-axis displays recall values as a percentage ranging from 30% to 100%, while the y-axis shows confidence values ranging from 0% to 100%. Each curve in the diagram illustrates how confidence changes with recall for each model.

FIG. 7 demonstrates that, for the same recall values, the hybrid model of the present invention achieves the highest confidence compared to all other models. Although the YOLOv7 model exhibits relatively good performance, its accuracy is lower than that of the hybrid model of the present invention. YOLOv5 and YOLOv7 are faster than both Faster R-CNN and the hybrid model of the present invention, but they also have lower accuracy compared to the hybrid model. On the other hand, Faster R-CNN has higher accuracy than YOLOv7 and YOLOv5, but its processing speed is slower.

It was observed that when the recall value exceeds 65%, the confidence of the hybrid model of the present invention becomes lower than that of Faster R-CNN. This discrepancy is likely due to the trade-off between recall and confidence.

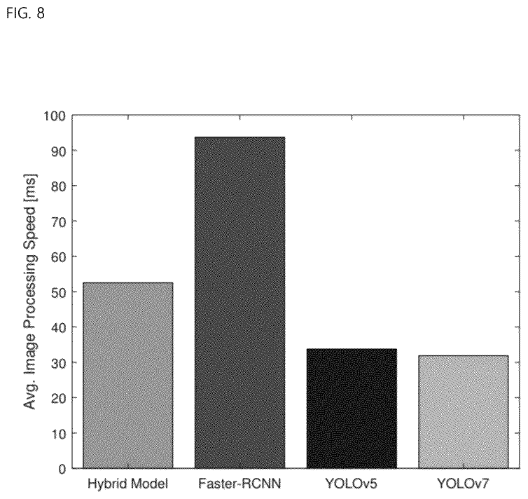

FIG. 8 is a diagram comparing the processing speeds of various recent object detection models. It shows the average processing time per image, measured in milliseconds (ms), for each model.

The model of the present invention requires an average processing time of 52 ms per image, making it the third fastest among the four models compared. Among these models, the Faster R-CNN model is the slowest, with an average processing time of 92 ms per image. Generally, for effective object detection in vehicle environments, a processing time of at least 62.5 ms per image, equivalent to 16 frames per second, is required.

The YOLOv5 model ranks second in terms of speed, with an average processing time of 32 ms per image. The YOLOv7 model is the fastest, recording an average processing time of 30 ms per image.

TABLE 1

| Model | Accuracy (%) | Processing Time (ms) | Recall (%) |
|---|---|---|---|
| Hybrid Model | 74.3 | 52 | 86 |
| YOLOv5 | 67.5 | 32 | 80 |
| YOLOv7 | 68.2 | 30 | 82 |
| Faster R-CNN | 79.1 | 92 | 90 |

Table 1 shows the object detection performance of the hybrid model of the present invention, YOLOv5, YOLOv7, and Faster R-CNN.

Overall, the results in FIGS. 6 through 8 demonstrate that the hybrid model of the present invention outperforms the other models in terms of accuracy. It excels in accuracy and supports practical real-time object detection applications in autonomous vehicles.

FIG. 9 illustrates the configuration of the object detection system 100 using a hybrid deep learning model. The object detection system 100 comprises a processor 110, a non-volatile storage unit 120 for storing programs and data, a volatile memory 130 for storing programs in execution, a communication unit 140 for communication with external devices 300, and a bus that serves as an internal communication pathway among these components. The running programs may include device drivers, the operating system (OS), and various applications. Although not shown in the diagram, the object detection system 100 using a hybrid deep learning model may also include a power supply unit, such as a battery.

The hybrid deep learning object detection model 210 is an application program installed in the object detection system 100 that operates using a deep learning algorithm. As described with reference to FIGS. 1 through 8, the hybrid deep learning object detection model 210 performs object detection on the collected video data. The external device 300 can be a camera or similar device that captures and transmits the video data.

What is claimed is:

1. A method for object detection by using a hybrid deep learning object detection model, comprising:
(a) collecting captured images in real time;
(b) performing preprocessing on the collected image data;
(c) inputting the preprocessed image data into the hybrid deep learning object detection model to execute the model algorithm; and
(d) outputting classification or segmentation from the hybrid deep learning object detection model.

2. The method of claim 1, wherein the step (c) includes:
(c1) extracting a bounding box for feature extraction from the preprocessed image data; and
(c2) outputting classification or segmentation from the image in which the bounding box has been extracted.

3. The method of claim 2, wherein the extraction of the bounding box in step (c1) includes inputting the preprocessed image data into the YOLO block of the hybrid deep learning object detection model, wherein the bounding box is extracted by the YOLO model.

4. The method of claim 3, wherein the step (c2) includes:
(c21) inputting the image, from which the bounding box has been extracted, into the Faster R-CNN block of the hybrid deep learning object detection model;
(c22) performing Region of Interest (RoI) pooling on the input image in the Faster R-CNN block; and
(c23) inputting the RoI pooled images into the Fully Connected CNN of the Faster R-CNN block,
wherein the output of the Fully Connected CNN in step (c23) is processed by a softmax classifier to output classification or segmentation in step (d).

5. A system for object detection by using a hybrid deep learning model, comprising:
at least one processor; and
at least one memory storing computer-executable instructions that, when executed by the at least one processor, cause the system to:
(a) collect captured images in real time;
(b) perform preprocessing on the collected image data;
(c) input the preprocessed image data into the hybrid deep learning model; and
(d) output classification or segmentation from the hybrid deep learning model.

6. The system of claim 5, wherein the step (c) includes:
(c1) extracting a bounding box for feature extraction from the preprocessed image data; and
(c2) outputting classification or segmentation from the image in which the bounding box has been extracted.

7. The system of claim 6, wherein the extraction of the bounding box in step (c1) includes inputting the preprocessed image data into the YOLO block of the hybrid deep learning object detection model, wherein the bounding box is extracted by the YOLO model.

8. The system of claim 7, wherein the step (c2) includes:
(c21) inputting the image, from which the bounding box has been extracted, into the Faster R-CNN block of the hybrid deep learning object detection model;
(c22) performing Region of Interest (RoI) pooling on the input image in the Faster R-CNN block; and
(c23) inputting the RoI pooled images into the Fully Connected CNN of the Faster R-CNN block,
wherein the output of the Fully Connected CNN in step (c23) is processed by a softmax classifier to output classification or segmentation in step (d).

9. A computer-readable non-transitory storage medium storing instructions that, when executed by a processor, cause the processor to:
(a) collect captured images in real time;
(b) perform preprocessing on the collected image data;
(c) input the preprocessed image data into a hybrid deep learning model; and
(d) output classification or segmentation from the hybrid deep learning model.
